(19) United States
(12) Patent Application Publication
(10) Pub. No.: US 2009/0251321 A1
(43) Pub. Date: Oct. 8, 2009

(54) Aqua Alert Swimming Monitor for the Prevention of Accidental Drowning

(76) Inventor: Darren George Delorey, Milton (CA)

Correspondence Address: Darren Delorey, 289 Bastedo Court, Milton, ON, L9T 3P9, CA

(21) Appl. No.: 12/062,673

(22) Filed: Apr. 4, 2008

(51) Int. Cl. G08B 21/02

(52) U.S. Cl. 340/573.6

(57) ABSTRACT

A drowning alarm and position marking system is described herein. The Aqua Alert is a system for detecting the drowning of an individual and subsequent generation of an alarm to alert a parent, lifeguard or by-standers. The system consists of two different units, a portable unit worn by the swimmer and a base station which is worn by a parent/supervisor or located on the beach, pool or boat. The buoyant portable unit transmits a signal which may be ultra-sonic, sub-sonic, audio or optic, but preferably radio frequency in nature. This signal is transmitted semi continuously until the portable unit is submerged in water in which case the signal is cut off from the base station due to the attenuating effects of being submerged in water. The base station will generate an alarm such as a siren or visual means or both if the signal from the portable unit is not received for a period of approximately 10 seconds, thus operating in a fail-safe condition. The portable unit has an on board means of sensing submersion in water and after being submerged for approximately 10 seconds will release a stored line which will allow the unit to remain attached to the drowning individual but float to the surface where both a highly reflective coating and a super high intensity LED will indicate the position of the drowning individual. The system may also act as a proximity monitor as the base station will alarm if the swimmer's distance exceeds the transmitting range of the portable unit, which is approximately 200 feet.

### FIELD OF THE INVENTION

This invention relates to drowning alarms, that is, devices that generate an alarm when an individual is drowning so that a parent/supervisor, lifeguard or by-stander is alerted to the drowning individual and rescue measures can be taken.

### BACKGROUND OF INVENTION

Each year there are many unnecessary and tragic drowning incidents which occur due to the fact the drowning individual goes unnoticed. These drowning incidents take place in swimming pools and large bodies of water. If the parent, lifeguard or by-standers are alerted to the drowning individual, the individual has a significantly greater chance of being rescued.

The available patent literature contains a number of patents for devices, which generate alarms in the event of a drowning individual in order to alert a parent, lifeguard or by-stander. Prior art Canadian Patents include CA 2448042 (Mandrel, 2003). Prior art United States Patents include U.S. Pat. No. 5,619,187 (Serfontein, 1997), U.S. Pat. No. 5,463,598 (Holland, 1995), U.S. Pat. No. 5,408,222 (Yaffe, 1995) and U.S. Pat. No. 4,813,025 (Rowland, 1989).

### SUMMARY OF INVENTION

The object of the invention is a drowning alarm and position marking system for the purpose of alerting a parent, lifeguard or by-stander to the drowning individual as well as providing a means of quickly locating the drowning individual. This invention addresses the shortcomings of the prior art patents. Characteristics which demonstrate these shortcomings include the fact that the signal is transmitted semi continuously until the portable unit is submerged in water in which case the signal is cut off from the base station due to the attenuating effects of being submerged in water thus operating in a fail safe condition, provides a means of directing the potential rescuers to the drowning individual, provides a means of marking the position of the submerged drowning individual, acts as a proximity monitor as the base station will alarm if the swimmer is out of range, provides a means of separating portable unit transmitted signals through the use of programmable digitally-encoded-fD or signal frequency, is simple in operation and design and is inexpensive to produce.

The system consists of two different units, a portable unit worn by the swimmer and a base station which is worn by a parent/supervisor or located on the beach, pool or boat. The buoyant portable unit transmits a signal which may be ultra-sonic, sub-sonic, audio or optic, but preferably radio frequency in nature. This signal is transmitted semi continuously until the portable unit is submerged in water in which case the signal is cut off from the base station due to the attenuating effects of being submerged in water. The base station will generate an alarm such as a siren or visual means or both if the signal from the portable unit is not received for a period of approximately 10 seconds, thus operating in a fail-safe condition. The portable unit has an on board means of sensing submersion in water and after being submerged for approximately 10 seconds will release a stored line which will allow the unit to remain attached to the drowning individual but float to the surface where both a highly reflective coating and a super high intensity LED will indicate the position of the drowning individual. Additionally, the base station shall incorporate a directional antenna and a related LED display to indicate the immediate direction of the floating portable unit. The transmitted signal from the portable unit may also be manually disabled by the swimmer by means of a quick disconnect mechanism connecting the portable unit to the elastic strap (necklace) worn by the swimmer resulting in the activation of the onboard marking system as well as the activation of the base station alarm. Both the connection of the portable unit to the elastic strap (necklace) and the strap itself will incorporate a disconnect mechanism which will either disconnect (upon sufficient pulling force) said portable unit from the elastic strap and/or release the elastic strap from around the swimmer's neck (or other appendage/body location) in case either said portable unit and/or elastic strap should be caught in a foreign body, thus preventing the possibility of swimmer entanglement in said foreign body. The system may also act as a proximity monitor as the base station will alarm if the swimmer's distance exceeds the transmitting range of the portable unit, which is approximately 200 feet.

The embodiments of the invention in which an exclusive property or privilege is claimed are defined as follows:

1. A drowning alarm and position marking system comprised of a plurality of portable units each worn by a swimmer and a base station for generating a drowning alarm either worn by a parent/supervisor or located on a pool, beach or boat.

2. The drowning alarm and position marking system described in claim 1, wherein said portable unit transmits a semi-continuous radio frequency signal which is received by said base station unless said portable unit is submerged in water whereby the transmitted signal is significantly attenuated and the base station no longer receives the transmitted signal thus operating in a fail safe condition.

3. The drowning alarm and position marking system described in claim 1, wherein said base station generates an alarm when the transmitted signal from said portable unit is not received for a period of approximately 10 seconds.

4. The drowning alarm and position marking system described in claim 1, wherein said portable unit has a means for disabling it's transmitted signal manually by the swimmer thus activating the onboard marking system and base station alarm.

5. The drowning alarm and position marking system described in claim 1, wherein said portable unit is buoyant and self-orientating in water.

6. The drowning alarm and position marking system described in claim 1, wherein said portable unit incorporates a preferred optical means of sensing submersion in water and after being submerged for approximately 10 seconds will activate the on board marking system, releasing a stored line which will allow the unit to remain attached to the drowning individual but float to the surface where both a highly reflective coating and a super high intensity LED will indicate the position of the drowning individual.

7. The drowning alarm and position marking system described in claim 1, wherein said base station generates an alarm by means of a loud audio signal and LED indicator.

8. The drowning alarm and position marking system described in claim 1, wherein said base station incorporates a directional antenna and a related LED display to indicate the immediate direction of the floating portable unit.

9. The drowning alarm and position marking system described in claim 1, wherein said portable unit is attached to the swimmer via an elastic strap which is worn by the swimmer preferably on the neck but may also be worn on the wrist, ankle, arm, leg or head or may be clipped onto any piece of clothing worn by the swimmer.

10. The portable unit described in claim 9, wherein said portable unit is connected to said elastic strap by means of a quick disconnect mechanism which will disconnect under sufficiently applied pulling force. The act of disconnecting the transmitting module from the elastic strap will automatically activate the manual alarm. The sensing of the disconnection from of the portable unit from the elastic strap is provided preferably by an optical sensor located inside the portable unit but can also be sensed by other means such as a hall-effect sensor located inside the portable unit.

11. The elastic strap as described in claim 9, and 10, wherein said elastic strap incorporates a separate quick disconnect mechanism which will release the strap from around the swimmer under sufficiently applied pulling force.

12. The drowning alarm and position marking system described in claim 1, wherein said portable unit transmits a pulse-width modulated signal with an approximate duty cycle of 100 ms ON and 1900 ms OFF for the purpose of saving the energy stored in the onboard battery.

13. The drowning alarm and position marking system described in claim 1, wherein said portable unit is battery operated and is housed in a watertight enclosure.

14. The drowning alarm and position marking system described in claim 1, wherein said base station is battery operated and is housed in a watertight enclosure.

15. The position marking system described in claim 6, wherein said position marking system is comprised of a stored line attached at one end to said floating portable unit and at the other end to the swimmer. Upon activation of the marking system, said line is released by means of an electronic lock release mechanism thus allowing the line to freely un-spool from said portable unit and allowing said portable unit to float to the surface. Said line shall be manually re-spooled and stored in said portable unit for future reuse.

16. The drowning alarm and position marking system described in claim 1, wherein said portable unit transmits a pulse-width modulated signal which incorporates a programmable digitally encoded ID or signal frequency to separate and identify to the related base station different transmitting portable units.

17. The drowning alarm and position marking system described in claim 1, wherein said portable unit consists of a portable transmitting module connected to a necklace with elastic properties.
